(19) United States
(12) Patent Application Publication
(10) Pub. No.: US 2021/0178659 A1
(43) Pub. Date: Jun. 17, 2021

(54) GROOVED DIE FOR MANUFACTURING UNIDIRECTIONAL TAPE

(71) Applicant: Saudi Arabian Oil Company, Dhahran (SA)

(72) Inventors: Abderrahim Fakiri, Dhahran (SA); Abdullatif Jazzar, Al-Khobar (SA); Hassan Ali Al-Hashmy, Dhahran (SA)

(73) Assignee: Saudi Arabian Oil Company, Dhahran (SA)

(21) Appl. No.: 16/717,584

(22) Filed: Dec. 17, 2019

(51) Int. Cl. B29C 64/118; B29C 64/205

(52) U.S. Cl. CPC B29C 64/118; B29K 2101/12; B29C 64/205

(57) ABSTRACT

A method of manufacturing thermoplastic components includes receiving, by a movable die with an internal grooved surface that has a plurality of longitudinal grooves, spread dry fiber tows. The method also includes receiving, by the movable die and from a polymer extruder, molten polymer. The method also includes wetting, by the movable die, the spread fiber tows with the molten polymer. The method also includes moving, by the movable die, the wet fiber tows along the plurality of longitudinal grooves in a direction parallel to a length of the longitudinal grooves. The method also includes depositing, by the movable die, a layer of the wet fiber tows on a printing surface. The movable die moves along the printing surface to form a thermoplastic component of one or more layers of fiber tows on the printing surface.

### FIELD OF THE DISCLOSURE

This disclosure relates to manufacturing plastics, in particular, to methods and equipment for manufacturing thermoplastics.

### BACKGROUND OF THE DISCLOSURE

Thermoplastic components can be made with continuous reinforced fibers, such as carbon fiber, glass fiber, or aramid fiber. Thermoplastic components exhibit high stiffness-to-weight ratios and other mechanical properties that make them desirable in multiple applications. Manufacturing thermoplastic components can be costly and time-consuming. Methods and systems for manufacturing thermoplastic components are sought.

### SUMMARY

Implementations of the present disclosure include a method of manufacturing thermoplastic components. The method includes receiving, by a movable die with an internal grooved surface that has a plurality of longitudinal grooves, spread dry fiber tows. The method also includes receiving, by the movable die and from a polymer extruder fluidically coupled to the movable die, molten polymer. The method also includes wetting, by the movable die, the spread fiber tows with the molten polymer. The method also includes moving, by the movable die, the wet fiber tows along the plurality of longitudinal grooves in a direction parallel to a length of the longitudinal grooves. The longitudinal grooves help prevent the wet fiber tows from mingling as the wet fiber tows move along the longitudinal grooves to exit the movable die. The method also includes depositing, by the movable die, a layer of the wet fiber tows on a printing surface. The movable die moves along the printing surface to form a thermoplastic component of one or more layers of fiber tows on the printing surface.

In some implementations, the movable die has an internal channel fluidically coupled to the polymer extruder. The internal channel flows the molten polymer from the polymer extruder to the internal grooved surface of the movable die. Wetting the spread fiber tows includes wetting the spread fiber tows at the internal grooved surface as the wet fiber tows move along the internal grooved surface. In some implementations, the internal channel is disposed upstream of the internal grooved surface and extends parallel to a length of the longitudinal grooves. In such implementations, wetting the spread fiber tows includes flowing the molten polymer into the internal grooved surface to flow along the longitudinal grooves. In some implementations, the internal channel extends from a fluid inlet of the movable die to the internal grooved surface, with the movable die having a fiber inlet disposed downstream of the fluid inlet. In such implementations, receiving the spread dry fiber tows includes receiving the spread dry fiber tows at such fiber inlet of the movable die. In such implementations, the internal channel is disposed at the internal grooved surface and extends laterally across the internal grooved surface, and wetting the spread fiber tows includes flowing the molten polymer across the longitudinal grooves. In such implementations, the internal channel extends from a fluid inlet disposed at a first elevation with respect to the printing surface and the movable die includes a fiber inlet disposed at a second elevation with respect to the printing surface. The second elevation is larger than the first elevation, and receiving the spread dry fiber tows includes receiving the spread dry fiber tows at the fiber inlet of the movable die with the dry fiber tows extending generally parallel with respect to the longitudinal grooves.

In some implementations, wetting the spread fiber tows includes generally uniformly contacting the fiber tows with the molten polymer.

In some implementations, the movable die is coupled to an additive manufacturing actuator system configured to move the movable die along the printing surface. Depositing the layer of the wet fiber tows includes depositing layers of the wet fiber tows on the printing surface to form a preform object in a semi-consolidated state.

Implementations of the present disclosure include an apparatus for manufacturing thermoplastic components. The apparatus includes a fiber spreader configured to spread dry fiber tows, a polymer extruder, and a movable die fluidically coupled to the polymer extruder to receive molten polymer from the polymer extruder. The movable die receives the spread dry fiber tows from the fiber spreader. The movable die includes an internal grooved surface defining longitudinal grooves extending between an inlet of the movable die and an outlet of the movable die through which the fiber tows exit the movable die. The inlet receives the spread dry fiber tows from the fiber spreader. The movable die also includes an internal channel configured to flow the molten polymer from a fluid inlet of the internal channel to the dry fiber tows to wet the dry fiber tows. The longitudinal grooves help prevent the wet fiber tows from mingling as the wet fiber tows move along the longitudinal grooves to exit the movable die. The die deposits a layer of the wet fiber tows on a printing surface to form a thermoplastic component of one or more layers of fiber tows on the printing surface.

In some implementations, the grooves extend in a direction parallel to a moving direction of the spread dry fiber tows. The grooves extend from the inlet of the movable die to the outlet of the movable die.

In some implementations, the outlet includes a flat lip configured to level the surface of the layer of the wet fiber tows to deposit a layer of generally uniform thickness.

In some implementations, each longitudinal groove includes a width of about 500 to 1000 micrometers.

In some implementations, the movable die further includes a cover plate disposed on top of the grooved surface. The movable die maintains the spread fiber tows in the longitudinal grooves. In some implementations, the outlet of the movable die is defined between a first flat lip adjacent the grooved surface and a second flat lip opposing the first flat lip. The second flat lip extends from the cover plate. The second flat lip levels, with the first flat lip, the surface of the layer of the wet fiber tows to deposit a layer of generally uniform thickness.

In some implementations, the internal channel is disposed upstream of the internal grooved surface and extends parallel to the length of the longitudinal grooves. The internal channel flows the molten polymer into the internal grooved surface to flow along the longitudinal grooves to wet the dry fiber tows.

In some implementations, the internal channel extends from the fluid inlet of the movable die to the internal grooved surface. The inlet of the movable die is disposed downstream of the fluid inlet adjacent a first end of the internal grooved surface to direct the spread fiber tows toward the internal grooved surface.

In some implementations, the longitudinal grooves of the internal grooved surface extend from the inlet of the movable die to the outlet of the movable die. The internal channel is disposed at the internal grooved surface and extends laterally across the internal grooved surface. The internal channel flows the molten polymer across the longitudinal grooves to wet the dry fiber tows. In some implementations, the fluid inlet is disposed at a first elevation with respect to the printing surface and the inlet of the movable die is disposed at a second elevation with respect to the printing surface. The second elevation is larger than the first elevation, and the movable die is configured to receive the dry fiber tows extending generally parallel with respect to the longitudinal grooves.

In some implementations, the apparatus also includes an additive manufacturing actuator system coupled to the movable die. The additive manufacturing actuator system moves the movable die along the printing surface to lay layers of the wet fiber tows on the printing surface to form a preform object in a semi-consolidated state.

Implementations of the present disclosure also include a movable die that includes a grooved surface that defines longitudinal grooves extending between an inlet and an outlet of the movable die. The inlet receives spread dry fiber tows. The movable die also includes a fluid channel fluidically coupled to a fluid source configured to flow fluid into the fluid channel. The fluid channel flows the fluid to the dry fiber tows to contact the dry fiber tows with the fluid. The longitudinal grooves are configured to help maintain the spread fiber tows spread as the fiber tows move along the longitudinal grooves to exit the movable die. The movable die deposits a layer of the fiber tows on a surface to form a component of one or more layers of fiber tows on the surface.

### BRIEF DESCRIPTION OF THE DRAWINGS

FIG. 1 is a side schematic view of a printing system according to a first implementation of the present disclosure.

FIG. 2 is a front schematic view of the printing system of FIG. 1.

FIG. 3 is a perspective exploded view of a grooved die of the printing system of FIG. 1.

FIG. 4A is a top view of a first portion of the grooved die of FIG. 3.

FIG. 4B is a top view of a second portion of the grooved die of FIG. 3.

FIG. 5 is a front schematic view of a printing system according to a second implementation of the present disclosure.

FIG. 6 is a perspective exploded view of a grooved die of the printing system of FIG. 5.

FIG. 7A is a top view of a first portion of the grooved die of FIG. 6.

FIG. 7B is a top view of a second portion of the grooved die of FIG. 6.

FIG. 8 is a flow chart of an example method of manufacturing thermoplastic components.

### DETAILED DESCRIPTION OF THE DISCLOSURE

The present disclosure describes a grooved die for a printing apparatus used to manufacture thermoplastic components. The grooved die receives spread fiber tows and wets the fiber tows with molten polymer before depositing layers of the wet fiber tows on a printing surface. The grooved die is connected to an additive manufacturing actuator system that moves the grooved die to deposit layers of the wet fiber tows on the printing surface to form two-dimensional thermoplastic components. The grooved die defines longitudinal grooves that help maintain the fiber tows spread as the fiber tows move along the die.

Particular implementations of the subject matter described in this specification can be implemented so as to realize one or more of the following advantages. For example, using a grooved die in a printing apparatus allows thermoplastic layers to be deposited with the fibers separated, ensuring fibers wettability, fibers uniformity, and increasing the quality of the final product.

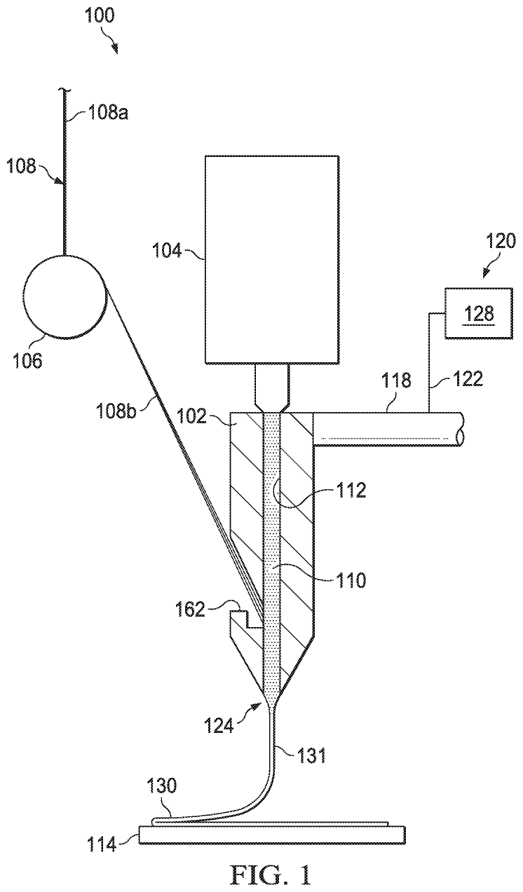

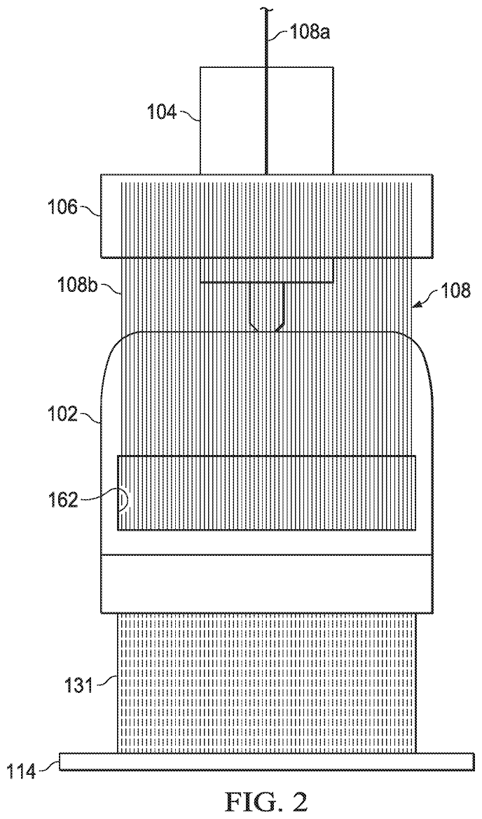

FIGS. 1 and 2 show a printing apparatus or system 100 for manufacturing thermoplastic components 130. The thermoplastic components 130 can be, for example, thermoplastic preforms in a semi-consolidated state. The printing apparatus 100 includes a grooved die 102 (for example, a movable die), a polymer extruder 104 fluidically coupled to the grooved die 102, one or more fiber spreaders 106 that spread dry fiber tows 108, a printing surface 114 (for example, a printing bed), and an additive manufacturing actuator system 120 (for example, a gantry or a multi-axis robotic system) coupled to the die 102. As shown in FIG. 1, the additive manufacturing actuator system 120 includes one or more actuators 118 (for example, linear actuators) and a processing device 128 (for example, a computer) communicatively coupled to the actuators 118. The processing device 118 has additive manufacturing software to control the actuators 118 to move the grooved die 102 along the printing surface 114 to deposit layers 131 of wet fiber tows 108 on the printing surface 114. The grooved die 102 can deposit layers 131 to form two-dimensional or three-dimensional thermoplastic components 130. For example, the grooved die 102 can print or form preform objects in a semi-consolidated state.

Referring to FIG. 2, the fiber spreader 106 spreads the fiber tows 108 from bundled fiber tows 108a to a continuous warp of spread fiber tows 108b. The fiber tows 108 can be made, for example, of carbon fiber. As shown in FIG. 1, the spread fiber tows 108b enter the die 102 through a side opening or inlet 162 to be wetted with a melted polymer 110 (for example, a matrix material such as an epoxy resin) inside the grooved die 102. The wet fiber tows 10 are deposited on the printing surface 114 by the die 114 to form layers of unidirectional tape (UD tape).

Referring to FIG. 1, the grooved die 102 has an interior channel 112 fluidically coupled to the polymer extruder 104 to receive the molten polymer 110 from the polymer extruder 104. The fiber tows 108 enter the interior channel 112 to be wetted with the polymer 110 and then exit the die 102 through an exit or outlet 124 of the grooved die 102. The molten polymer 110 flows along the channel toward the spread fiber tows 108 to wet or impregnate the fiber tows 108 at the interior channel 112. The wet fiber tows 108 form a layer 131 of continuous UD tape that the die 102 lays or deposits on the printing surface 114. The grooved die 102 forms thermoplastic components 130 with multiple layers 131 of continuous UD tape. For example, the grooved die 102 deposits the first layer and then waits for the layer to dry and stick to the printing surface 114. The dry layer acts as an anchor to pull the subsequent fiber layers during the tape laying process. The grooved die 102 moves along the printing surface 114 to form thermoplastic components 130 of one or more layers 131 of wet fiber tows on the printing surface 114.

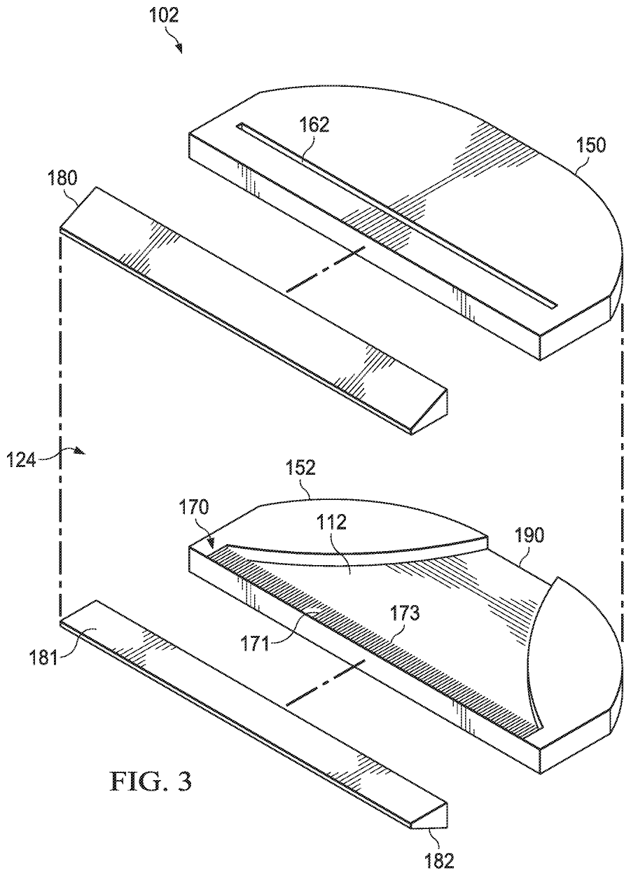

FIG. 3 shows an exploded view of the grooved die 102. The grooved die 102 has a first plate 152 attached to a cover plate 150 disposed on top of (or adjacent to) the first plate 152. The first plate 152 has an internal grooved surface 170 that defines longitudinal grooves 171 extending between an inlet 162 of the grooved die and the outlet 124 of the grooved die through which the fiber tows exit the grooved die 102. The inlet 162 receives the spread dry fiber tows from the fiber spreader. The spread fiber tows 108 are directed by the inlet 162 to the grooved surface 170 to move the spread fiber tows along the grooved surface 170 in a direction parallel to a length of the longitudinal grooves 171. Specifically, the longitudinal grooves 171 extend in a direction parallel to a moving direction of the spread dry fiber tows 108b (see FIG. 1). The grooved die 102 also includes an internal fluid channel 112 that flows the molten polymer from a fluid inlet 190 of the internal channel 112 to the internal grooved surface 170 to wet the dry fiber tows. The longitudinal grooves 171 help prevent the wet fiber tows 108 from mingling as the wet fiber tows move along the longitudinal grooves 171 to exit the grooved die 102. In some implementations, the grooved surface 170 can extend beyond the inlet 162 into the grooved die 102.

The outlet 124 of the grooved die 102 has at least one flat lip 182 that levels the surface of the layer 131 of the wet fiber tows to deposit the layer 131 having a generally uniform thickness. The first flat lip 182 has a flat surface 181 downstream of the grooved surface 170 to flatten the layer 131 of wet fiber tows as the layer exits the grooved die 102. The cover plate 150 can have a second flat lip 180 opposed to the first flat lip 182. The second flat lip 180 defines, together with the first flat lip 181 of the first plate 152, the outlet 124 (for example, a longitudinal gap) of the grooved die 102. The second flat lip 180 extends from the cover plate 150 and levels, with the first flat lip 181, the surface of the layer 131 of the wet fiber tows to deposit a layer of generally uniform thickness.

The cover plate 150 is disposed on top of the grooved surface 170 to maintain the spread fiber tows 108b in the longitudinal grooves 171 to move along and within the longitudinal grooves 171. Each longitudinal groove 171 has a width of about 500 to 1000 micrometers to receive one or multiple fibers.

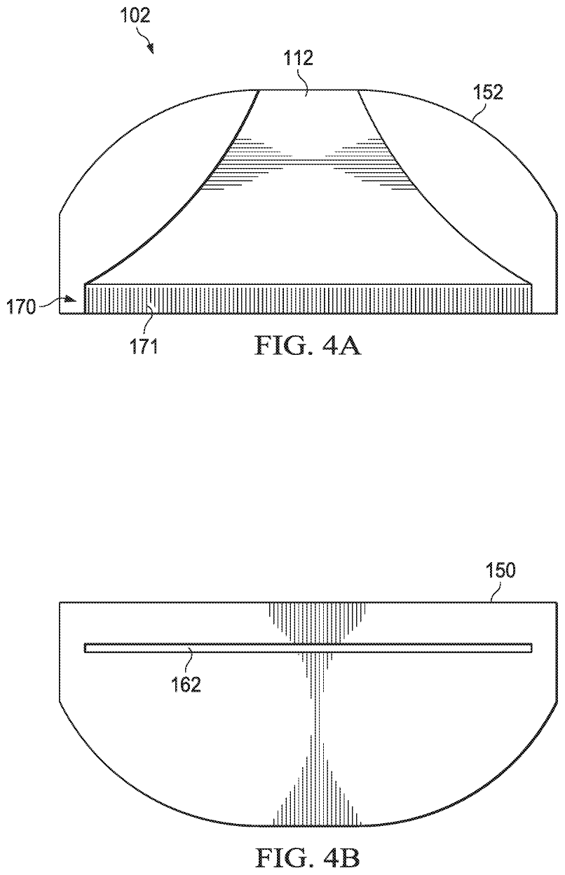

As shown in FIG. 4A, the internal fluid channel 112 is disposed upstream of the internal grooved surface 170 and extends in a direction parallel to the length of the longitudinal grooves 171 to flow the molten polymer generally along the direction of the longitudinal grooves 171. By upstream, it is meant that the fluid channel 112 is disposed in an opposite direction or location, with respect to the outlet 124, from the direction in which the molten polymer 110 flows. The internal channel 112 flows the molten polymer to the internal grooved surface 170 to flow along the longitudinal grooves 171 to wet the dry fiber tows 108. The fluid inlet 190 of the channel 112 has a width smaller than a width of the grooved surface 170. Thus, the channel increases in width toward the grooved surface 170 to spread or distribute the molten polymer. In some implementations, the channel 112 can include a distribution manifold (not shown) to evenly distribute the molten polymer to evenly wet the spread fiber tows 108. As shown in FIGS. 4A and 4B, the inlet 162 of the grooved die 102 is disposed downstream of the fluid inlet 190. The inlet 162 is adjacent a first end 173 of the internal grooved surface 170 to direct the spread fiber tows, starting from the first end 173, toward the internal grooved surface 170.

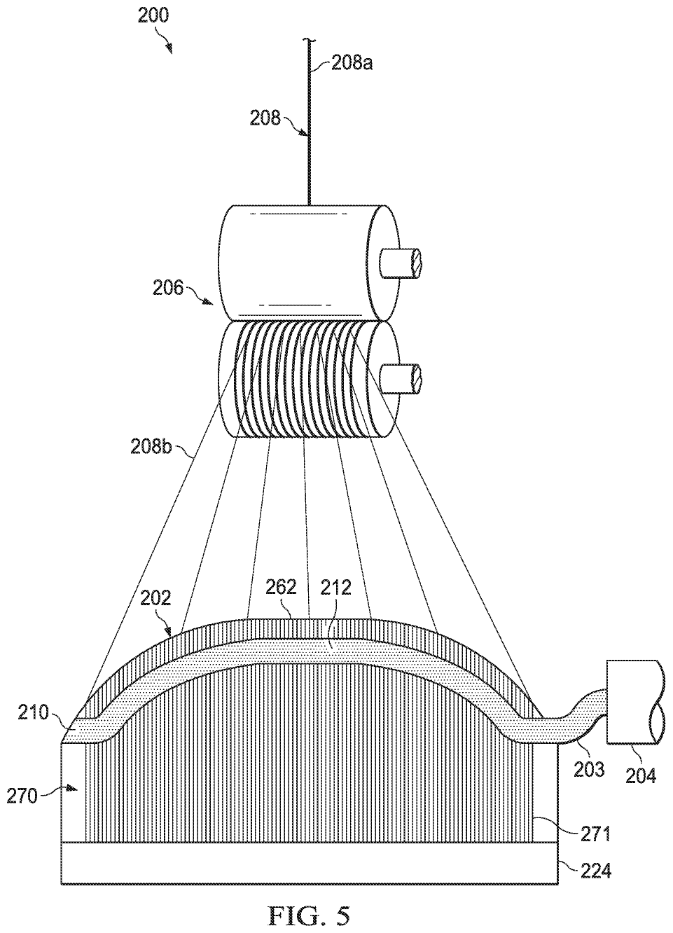

FIG. 5 shows a printing apparatus 200 according to a second implementation of the present disclosure. The printing apparatus 200 includes a grooved die, a polymer extruder 204 fluidically coupled to the grooved die 202, and one or more fiber spreaders 206 that spread dry fiber tows 208a to a continuous warp of spread fiber tows 208b. Similar to the printing apparatus of FIG. 1, the printing apparatus 200 also includes a printing surface and an additive manufacturing actuator system coupled to the die 202. The printing apparatus 200 has a grooved die 202 with a grooved surface 270 that spans a length of the grooved die 202. The printing apparatus 200 is similar to the printing apparatus of FIG. 1, with the main exception that the grooved die 202 receives the spread dry fiber tows 208 from a top inlet 262 rather than a side inlet.

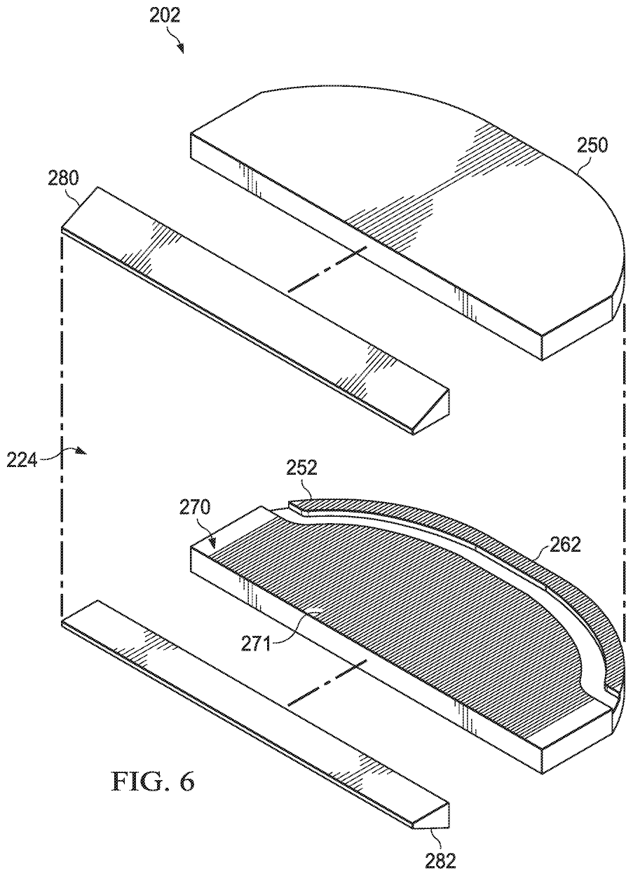

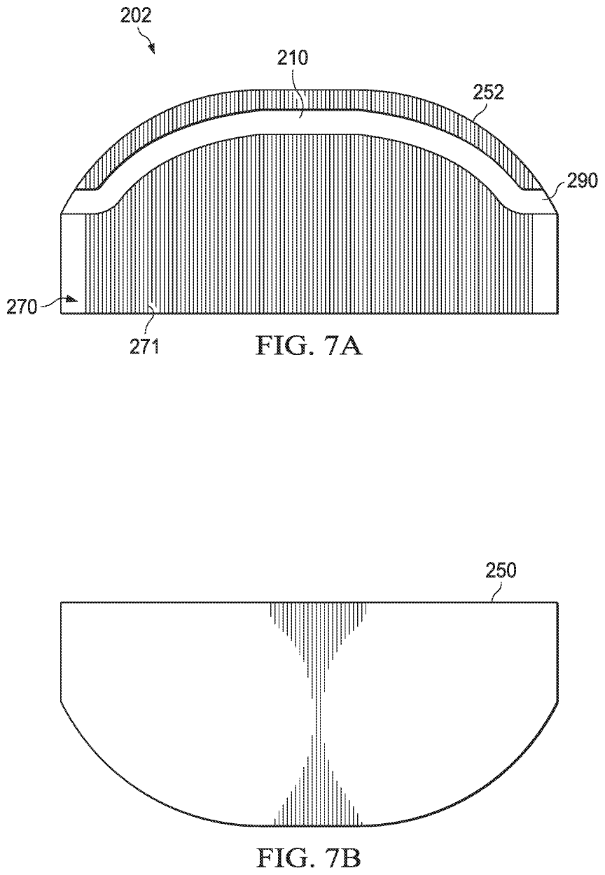

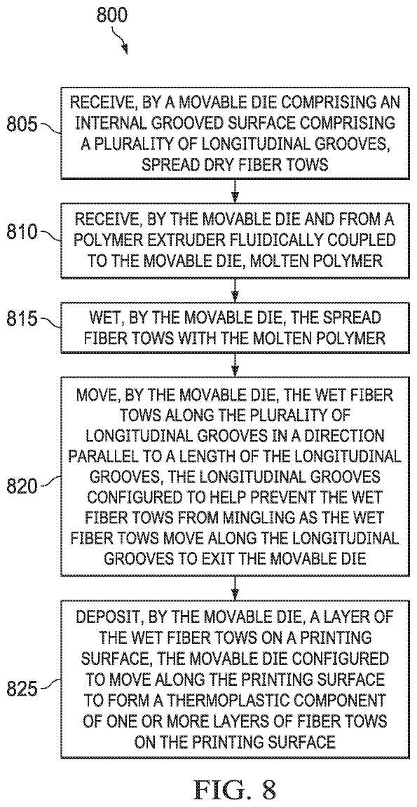

Referring to FIG. 6, the grooved die 202 has a grooved surface 270 that defines longitudinal grooves 271 that extend from the inlet 262 of the grooved die 202 to the outlet 224 of the grooved die 202. As shown in FIG. 7A, the internal fluid channel 210 of the grooved die 202 is disposed at the internal grooved surface 270 and extends generally laterally across the internal grooved surface 270. The internal fluid channel 210 flows the molten polymer across the longitudinal grooves 271 to wet the dry fiber tows 208 as the fiber tows move along the longitudinal grooves 271. The fluid channel has a fluid inlet 290 that is disposed at a first elevation with respect to the printing surface (or with respect to the outlet 224 of the grooved die 202). The inlet 262 of the grooved die 202 is disposed at a second elevation with respect to the printing surface. The second elevation is larger or higher than the first elevation. The grooved die 202 receives the dry fiber tows extending generally parallel with respect to the longitudinal grooves 270.

The present disclosure includes a method 800 of manufacturing thermoplastic components. The method includes receiving, by a movable die including an internal grooved surface including a plurality of longitudinal grooves, spread dry fiber tows (805). The method also includes receiving, by the movable die and from a polymer extruder fluidically coupled to the movable die, molten polymer (810). The method also includes wetting, by the movable die, the spread fiber tows with the molten polymer (815). The method also includes moving, by the movable die, the wet fiber tows along the plurality of longitudinal grooves in a direction parallel to a length of the longitudinal grooves, the longitudinal grooves configured to help prevent the wet fiber tows from mingling as the wet fiber tows move along the longitudinal grooves to exit the movable die (820). The method also includes depositing, by the movable die, a layer of the wet fiber tows on a printing surface, the movable die configured to move along the printing surface to form a thermoplastic component of one or more layers of fiber tows on the printing surface (825).

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A method of manufacturing thermoplastic components, the method comprising:
receiving, by a movable die comprising an internal grooved surface comprising a plurality of longitudinal grooves, spread dry fiber tows;
receiving by the movable die and from a polymer extruder fluidically coupled to the movable die, molten polymer;
wetting, by the movable die, the spread fiber tows with the molten polymer;
moving, by the movable die, the wet fiber tows along the plurality of longitudinal grooves in a direction parallel to a length of the longitudinal grooves, the longitudinal grooves configured to help prevent the wet fiber tows from mingling as the wet fiber tows move along the longitudinal grooves to exit the movable die; and
depositing, by the movable die, a layer of the wet fiber tows on a printing surface, the movable die configured to move along the printing surface to form a thermoplastic component of one or more layers of fiber tows on the printing surface.

2. The method of claim 1, wherein the movable die comprises an internal channel fluidically coupled to the polymer extruder, the internal channel configured to flow the molten polymer from the polymer extruder to the internal grooved surface of the movable die, and wherein wetting the spread fiber tows comprising wetting the spread fiber tows at the internal grooved surface as the wet fiber tows move along the internal grooved surface.

3. The method of claim 2, wherein the internal channel is disposed upstream of the internal grooved surface and extends parallel to a length of the longitudinal grooves, and wherein wetting the spread fiber tows comprises flowing the molten polymer into the internal grooved surface to flow along the longitudinal grooves.

4. The method of claim 3, wherein the internal channel extends from a fluid inlet of the movable die to the internal grooved surface, the movable die comprising a fiber inlet disposed downstream of the fluid inlet, and wherein receiving the spread dry fiber tows comprises receiving the spread dry fiber tows at the fiber inlet of the movable die.

5. The method of claim 2, wherein the internal channel is disposed at the internal grooved surface and extends laterally across the internal grooved surface, and wherein wetting the spread fiber tows comprises flowing the molten polymer across the longitudinal grooves.

6. The method of claim 5, wherein the internal channel extends from a fluid inlet disposed at a first elevation with respect to the printing surface and where the movable die comprises a fiber inlet disposed at a second elevation with respect to the printing surface, the second elevation larger than the first elevation, and wherein receiving the spread dry fiber tows comprises receiving the spread dry fiber tows at the fiber inlet of the movable die with the dry fiber tows extending generally parallel with respect to the longitudinal grooves.

7. The method of claim 1, wherein wetting the spread fiber tows comprises generally uniformly contacting the fiber tows with the molten polymer.

8. The method of claim 1, wherein the movable die is coupled to an additive manufacturing actuator system configured to move the movable die along the printing surface, and wherein depositing the layer of the wet fiber tows comprises depositing layers of the wet fiber tows on the printing surface to form a preform object in a semi-consolidated state.

9. An apparatus for manufacturing thermoplastic components, the apparatus comprising:
a fiber spreader configured to spread dry fiber tows;
a polymer extruder; and
a movable die fluidically coupled to the polymer extruder to receive molten polymer from the polymer extruder, the movable die configured to receive the spread dry fiber tows from the fiber spreader, the movable die comprising:
an internal grooved surface defining longitudinal grooves extending between an inlet of the movable die and an outlet of the movable die through which the fiber tows exit the movable die, the inlet configured to receive the spread dry fiber tows from the fiber spreader, and
an internal channel configured to flow the molten polymer from a fluid inlet of the internal channel to the dry fiber tows to wet the dry fiber tows, wherein the longitudinal grooves are configured to help prevent the wet fiber tows from mingling as the wet fiber tows move along the longitudinal grooves to exit the movable die, and wherein the die is configured to deposit a layer of the wet fiber tows on a printing surface to form a thermoplastic component of one or more layers of fiber tows on the printing surface.

10. The apparatus of claim 9, wherein the grooves extend in a direction parallel to a moving direction of the spread dry fiber tows, and wherein the grooves extend from the inlet of the movable die to the outlet of the movable die.

11. The apparatus of claim 9, wherein the outlet comprises a flat lip configured to level the surface of the layer of the wet fiber tows to deposit a layer of generally uniform thickness.

12. The apparatus of claim 9, wherein each longitudinal groove comprises a width of about 500 to 1000 micrometers.

13. The apparatus of claim 9, wherein the movable die further comprises a cover plate disposed on top of the grooved surface and configured to maintain the spread fiber tows in the longitudinal grooves.

14. The apparatus of claim 13, wherein the outlet of the movable die is defined between a first flat lip adjacent the grooved surface and a second flat lip opposing the first flat lip, the second flat lip extending from the cover plate and configured to level, with the first flat lip, the surface of the layer of the wet fiber tows to deposit a layer of generally uniform thickness.

15. The apparatus of claim 9, wherein the internal channel is disposed upstream of the internal grooved surface and extends parallel to the length of the longitudinal grooves, the internal channel configured to flow the molten polymer into the internal grooved surface to flow along the longitudinal grooves to wet the dry fiber tows.

16. The apparatus of claim 15, wherein the internal channel extends from the fluid inlet of the movable die to the internal grooved surface, and wherein the inlet of the movable die is disposed downstream of the fluid inlet adjacent a first end of the internal grooved surface to direct the spread fiber tows toward the internal grooved surface.

17. The apparatus of claim 9, wherein the longitudinal grooves of the internal grooved surface extend from the inlet of the movable die to the outlet of the movable die, wherein the internal channel is disposed at the internal grooved surface and extends laterally across the internal grooved surface, the internal channel configured to flow the molten polymer across the longitudinal grooves to wet the dry fiber tows.

18. The apparatus of claim 17, wherein the fluid inlet is disposed at a first elevation with respect to the printing surface and where the inlet of the movable die is disposed at a second elevation with respect to the printing surface, the second elevation larger than the first elevation, and wherein the movable die is configured to receive the dry fiber tows extending generally parallel with respect to the longitudinal grooves.

19. The apparatus of claim 9, further comprising an additive manufacturing actuator system coupled to the movable die, the additive manufacturing actuator system configured to move the movable die along the printing surface to lay layers of the wet fiber tows on the printing surface to form a preform object in a semi-consolidated state.

20. A movable die comprising:
a grooved surface defining longitudinal grooves extending between an inlet and an outlet of the movable die, the inlet configured to receive spread dry fiber tows; and
a fluid channel fluidically coupled to a fluid source configured to flow fluid into the fluid channel, the fluid channel configured to flow the fluid to the dry fiber tows to contact the dry fiber tows with the fluid, wherein the longitudinal grooves are configured to help maintain the spread fiber tows spread as the fiber tows move along the longitudinal grooves to exit the movable die, and wherein the movable die is configured to deposit a layer of the fiber tows on a surface to form a component of one or more layers of fiber tows on the surface.
